(19) United States
(12) Patent Application Publication
(10) Pub. No.: US 2026/0269773 A1
(43) Pub. Date: Sep. 10, 2026

(54) SOLAR TRACKER COMPONENT MOBILE CARRIERS

(71) Applicant: Nextpower LLC, Fremont, CA (US)

(72) Inventors: Nathan Malone, Fremont, CA (US); Alexander W. AU, Oakland, CA (US); Bethany Ramadan, Fremont, CA (US); Harry Van, Oakland, CA (US)

(21) Appl. No.: 19/555,267

(22) Filed: Mar. 3, 2026

Related U.S. Application Data
(60) Provisional application No. 63/768,303, filed on Mar. 7, 2025.
(60) Provisional application No. 63/970,064, filed on Jan. 28, 2026.

(51) Int. Cl. H02S 20/32; B25J 5/00; B25J 9/00; B60P 1/38; B65G 41/00

(52) U.S. Cl. CPC H02S 20/32; B25J 5/00; B25J 9/0093; B60P 1/38; B65G 41/002

(57) ABSTRACT

Methods and systems for transporting solar tracker components are disclosed herein. An autonomous mobile carrier unit includes a controller, a motive source coupled to the controller, one or more wheels coupled to the motive source to autonomously move the autonomous mobile carrier unit, and a conveyor mechanism coupled to the controller. The conveyor mechanism is configured to move one or more solar tracker components along the conveyor mechanism, relative to the one or more wheels.

### RELATED APPLICATIONS

This application claims the benefit of U.S. Provisional Patent Application No. 63/768,303, filed Mar. 7, 2025, and also claims the benefit of U.S. Provisional Patent Application No. 63/970,064, filed Jan. 28, 2026 the entire contents of both of which are incorporated herein by reference.

### TECHNICAL FIELD

This disclosure relates generally to mobile carriers for transporting components. More particularly, the present disclosure describes applications relating to one or more mobile carrier units for transporting one or more solar tracker components about a solar tracker site.

### BACKGROUND

Solar panels are generally composed of an array of solar cells, which are interconnected to each other. The cells are often arranged in series and/or parallel groups of cells in series. Solar cells and solar panels are typically more efficient in sunny conditions when oriented towards the sun at a certain angle (e.g., angled to present a solar panel surface area that is normal or perpendicular to the direction of incident rays of sunlight, a “normal incidence angle”). Many solar panel systems are designed in combination with solar trackers, which enable the solar panels or solar modules to follow the sun's trajectory across the sky from east to west throughout a typical day in an attempt to maximize the electrical generation capabilities of the solar panel systems.

Typically, a relatively large number of solar cells are arranged in an array to generate energy in sufficient amounts to be usable, for example as part of an energy grid. As a result, solar trackers have been developed that are quite large, spanning hundreds of feet in length and including hundreds of individual solar modules that are mechanically coupled to support structures. An array of solar trackers may be formed of a plurality of solar tracker rows that are oriented generally parallel to each other, often in a north-to-south configuration, which may facilitate rotating or tilting the solar modules throughout the day to attempt to follow the trajectory of the sun and maximize the energy produced.

Solar tracker systems can be quite large, including oftentimes at utility-scale. Accordingly, installing such solar tracker systems can involve a number of different components, which are generally manufactured offsite, brought on-site, and then need to be widely distributed across the relatively large area site at each of the many discrete locations where the individual components will be used.

### SUMMARY

Embodiments disclosed herein relate to mobile carrier devices, systems, and methods. In particular, embodiments disclosed herein describe mobile carriers configured to transport any of a variety of solar tracker components about a solar tracker site.

For example, solar tracker components can be loaded onto a mobile carrier. The mobile carrier can be configured to impart movement to such solar tracker components, relative to a body of the mobile carrier (e.g., relative to one or more wheel at the mobile carrier). This imparting of relative movement can cause the solar tracker components to be moved into or out of range of a robotic arm that can be configured to unload the solar tracker components from the mobile carrier. As another additional or alternative example, this imparting of relative movement can cause the solar tracker components to be moved off the mobile carrier and onto another different mobile carrier (e.g., which itself can be configured to impart movement to such received solar tracker components, relative to a body of that mobile carrier). Accordingly, embodiments disclosed herein can facilitate loading, transport, and/or unloading any of a variety of different types of solar tracker components, including the ability to impart relative movement to such solar tracker components at the mobile carrier to bring such solar tracker components (e.g., a first subset of solar tracker components at a first pallet) into or out of range of an unloading robotic arm and/or to move such solar tracker components from one mobile carrier to another different mobile carrier.

As another example, mobile carrier embodiments disclosed herein can utilize a centralized power storage component (e.g., battery) to distribute power to separate mobile carriers. For instance, a battery can be at a first mobile carrier, and a second, different mobile carrier, and/or robotic arm remote from the first carrier, can be electrically connected to the first mobile carrier such that the second mobile carrier and/or the robotic arm receives power from the battery at the first mobile carrier. In some such instances, the battery at the first mobile carrier can be coupled to a power converter (e.g., DC-AC converter) such that power transmitted from the battery at the first mobile carrier is altered (e.g., converted from DC to AC; inverted; or otherwise conditioned) prior to being utilized at the second mobile carrier and/or robotic arm. In some embodiments, the first mobile carrier can include onboard a motive source (e.g., electric motor)/drivetrain such that the first mobile carrier can be moved about the solar tracker site to transport solar tracker components to desired locations at the site.

One embodiment disclosed herein includes an autonomous mobile carrier unit. This unit embodiment includes a controller, a motive source coupled to the controller, one or more wheels coupled to the motive source to autonomously move the autonomous mobile carrier unit, and a conveyor mechanism coupled to the controller. The conveyor mechanism is configured to move one or more solar tracker components along the conveyor mechanism, relative to the one or more wheels.

In a further embodiment of this unit, the unit additionally includes a robotic arm that is configured to move relative to the conveyor mechanism. The robotic arm can also be configured to attach to the one or more solar tracker components at the conveyor mechanism. For example, the controller can be configured coordinate movement of the conveyor mechanism and the robotic arm using information relating to actuation of the conveyor.

In some embodiments of this unit, the unit can additionally include a body that includes each of the controller, the motive source, the one or more wheels, the conveyor mechanism, and the robotic arm as an integrated unit. In other embodiments of this unit, two or more different bodies can be included at the unit. For instance, the one or more wheels can include a first wheel and a second wheel, and the unit can additionally include a first body and second, different body. The first body can include the first wheel and the conveyor mechanism. The second, different body can be connected to the first body such that the first and second bodies move together, with the second body including the second wheel and the robotic arm. According to one such example, the first body and the second body can be electrically connected to convey power from a battery at one of the first body and the second body to the other of the first body and the second body.

In a further embodiment of this unit, the unit additionally includes a body that has at least one of the one or more wheels and the conveyor mechanism, and this body includes a ladder chassis that supports the conveyor mechanism. For example, the ladder chassis can include a compressive spring suspension at one end portion of the body and a leaf spring suspension at another opposite end portion of the body. The motive source can include a battery coupled to an electric motor, and the battery can be carried at the body at least between the compressive spring suspension and the leaf spring suspension. For instance, in some such examples, the electric motor can be carried at the end portion of the body comprising the compressive spring suspension.

In a further embodiment of this unit, the one or more wheels include a first wheel and a second wheel, with the first wheel controllable by the controller independent of the second wheel.

In a further embodiment of this unit, the conveyor mechanism includes a length sufficient to receive at least two spaced apart pallets of solar tracker components thereat. The conveyor mechanism can be configured to pivot relative to the one or more wheels to change an inclination angle of the conveyor mechanism. For example, the robotic arm is configured to attach to one or more of a first set of solar tracker components at a first time. The conveyor mechanism can be configured to move a second set of solar tracker components along the conveyor mechanism relative to the one or more wheels at a second, later time. And the robotic arm can be configured to remove the second set of solar tracker components from the conveyor after the second set of solar tracker components has been moved along the conveyor mechanism.

In a further embodiment of this unit, the one or more solar tracker components can include a first type of solar tracker component and a second, different type of solar tracker component. In some such examples, each of the first and second types of solar tracker components can be selected from the group consisting of: a ground support, a fastener, and a solar module. For instance, the first type of solar tracker component can be at a first location along the conveyor mechanism, and the second type of solar tracker component can be at a second location that is spaced apart from the first location along the conveyor mechanism.

Another embodiment disclosed herein includes a method of transporting solar tracker components. This method includes the steps of: receiving solar tracker component information relating to one or more types of solar tracker components loaded at a mobile carrier; using the solar tracker component information to determine a location to which to transport the solar tracker components loaded at a mobile carrier; and when the mobile carrier unit is at the location, actuating a robotic arm to remove the solar tracker components from the mobile carrier at the location.

In a further embodiment of this method, the solar tracker components loaded at the mobile carrier include each of a first type of solar tracker component and a second, different type of solar tracker component. For instance, the first type of solar tracker component can be selected from the group consisting of: a ground support, a fastener, and a solar module, and the second type of solar tracker component can be selected from the group consisting of: a ground, a fastener, and a solar module. In some such instances, the first type of solar tracker component can be loaded at a first location along a conveyor at the mobile carrier, and the second type of solar tracker component can be loaded at a second location that is spaced apart from the first location along the conveyor. Accordingly, the method can further include the steps of: after the robotic arm is actuated to remove the first type of solar tracker component from the conveyor, imparting movement of the second type of solar tracker component, relative to one or more wheels at the mobile carrier, to move the second type of solar tracker component within range of the robotic arm; and, after moving the second type of solar tracker component closer to the robotic arm, actuating the robotic arm to remove the second type of solar tracker components from the conveyor at the location. And, in a yet further embodiment, this method can further include the steps of: pivoting the conveyor, relative to one or more wheels at the mobile carrier, from a first orientation to a second, different orientation; and, when the conveyor is at the second orientation, loading the first type of solar tracker component using at least movement of the conveyor at the second orientation and then loading the second type of solar tracker component using at least movement of the conveyor at the second orientation.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a schematic, top view of a solar tracking system;

FIG. 3 is a schematic view of an autonomous mobile carrier unit in accordance with the disclosure;

FIG. 4A is a schematic view of a mobile carrier unit including a robot and a trailer having four wheels in accordance with the disclosure;

FIG. 4B is a schematic view of the mobile carrier unit, as in FIG. 4A, including the robot and the trailer having two wheels;

FIG. 5A is a schematic view of the autonomous mobile carrier unit, as in FIG. 3, having four wheels;

FIG. 5B is a schematic view of the autonomous mobile carrier unit, as in FIG. 3, having eight wheels;

FIG. 5C is a schematic view of the autonomous mobile carrier unit, as in FIG. 3, having four tracks;

FIG. 5D is a schematic view of the autonomous mobile carrier unit, as in FIG. 3, having two tracks;

FIG. 6A illustrates various drive train configurations for the autonomous mobile carrier unit, as in FIG. 3, and the mobile carrier unit, as in FIG. 4A;

FIG. 6B illustrates various wheel/axle configurations for the autonomous mobile carrier unit, as in FIG. 3, and the mobile carrier unit, as in FIG. 4A;

FIGS. 7A to 7D illustrate an example chassis configuration for the autonomous mobile carrier unit, as in FIG. 3, and the mobile carrier unit, as in FIG. 4A;

FIGS. 8A to 8D illustrate another example chassis configuration for the autonomous mobile carrier unit, as in FIG. 3, and the mobile carrier unit, as in FIG. 4A;

FIGS. 9A to 9D illustrate a method of loading the mobile carrier unit, as in FIG. 4A;

FIGS. 10A and 10B illustrate a further example mobile carrier unit, including the robot and a second trailer, in addition to the first mobile carrier unit, in accordance with the disclosure, where FIG. 10A shows solar module components as a type of solar tracker component transported by the mobile carrier unit, and FIG. 10B shows different solar module components loaded and moved at the mobile carrier unit in sequence corresponding to the specific types of different solar module components at the mobile carrier unit (e.g., as shown at FIG. 10B piles, followed by fasteners, followed by solar modules);

FIG. 11 is another example autonomous mobile carrier unit in accordance with the disclosure;

FIG. 12 illustrates a method of loading the autonomous mobile carrier unit, as in FIG. 3;

FIGS. 13A to 13D illustrate a method of loading the trailer of the mobile carrier unit, as in FIG. 4A, in accordance with the present disclosure; and

FIGS. 14A to 14D illustrate various arrangements of a battery and the trailer of the mobile carrier unit, as in FIG. 4A.

FIGS. 15A-15D illustrate an additional example mobile carrier unit including the robot and one or more trailers, such as at FIGS. 10A and 10B, and having an expandable and contractable tow line between the robot and first trailer and/or between the first trailer and the second trailer. FIGS. 15A and 15B show the mobile carrier unit's tow line at an example expanded position between the robot and the first trailer and between the first trailer and the second trailer. FIGS. 15C and 15D show the mobile carrier unit's tow line at an example contracted position between the robot and the first trailer and between the first trailer and the second trailer.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar tracker supports configured to facilitate improved structural stability for solar tracking systems. Certain embodiments disclosed herein can improve solar tracking system structural stability while increasing the efficiency of solar tracking foundation installation and reducing costs (e.g., foundation and/or support material costs) associated with solar tracker foundations and supports.

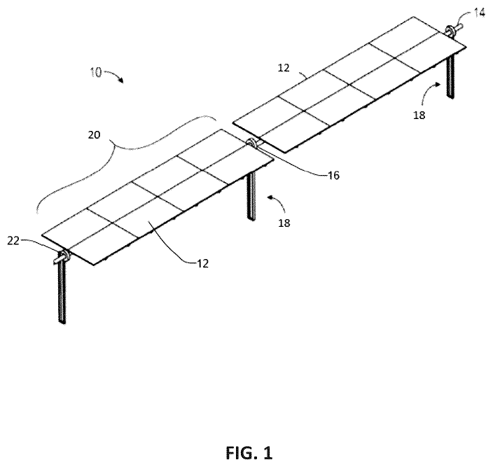

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedment in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

Since there is often just a single drive mechanism 16 for a row of solar trackers, the specifications for the torque tube 14 may desire to reduce twist of the torque tube 14 along its length. Any twist would result in the solar modules 12 being oriented differently from what is desired, and thus again reduce the output and efficiency of the solar tracker 10, particularly, as the solar tracker 10 is rotated towards the extreme angles of permitted range (e.g., +/−75 degrees or more). However, the desired flexibility in the torque tube for several purposes also leads to the torque tube being flexible enough to twist along its length as it extends away from the drive mechanism.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

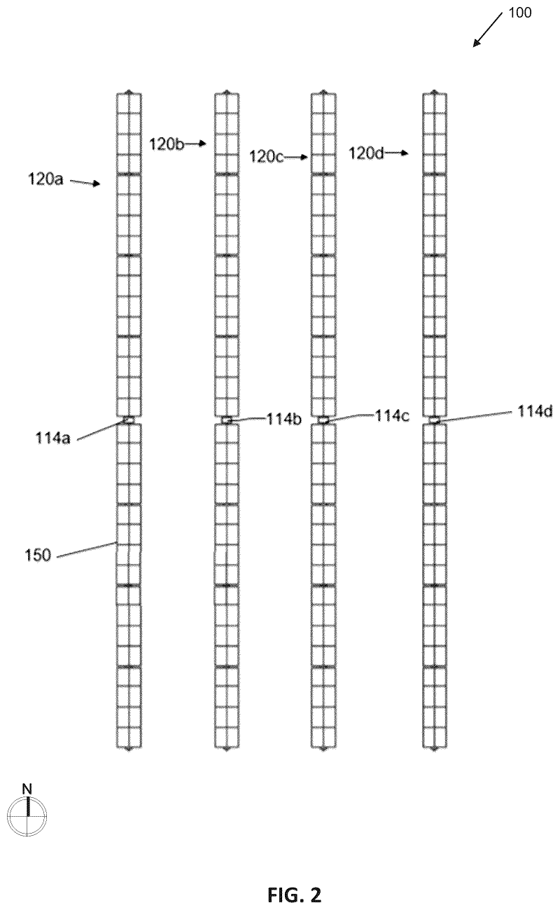

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

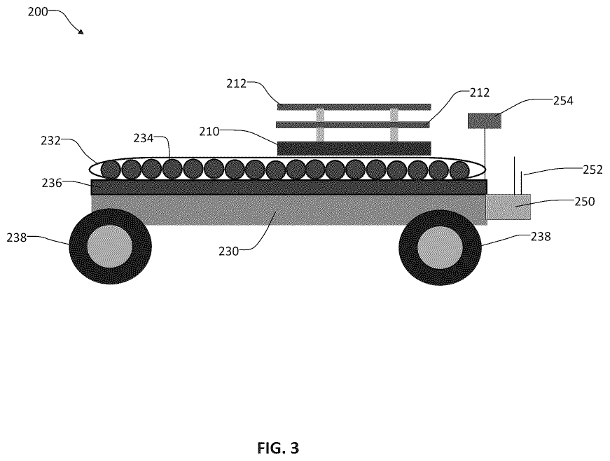

FIG. 3 is a schematic view of an autonomous mobile carrier unit 200 in accordance with the disclosure. The autonomous mobile carrier unit 200 may be a robotic transport system for loading, unloading, and transporting solar tracker components to/from a solar tracker installation site. As shown in FIG. 3, the autonomous mobile carrier unit 200 may include a robot 230, a battery 236, a conveyer belt 232 and a plurality of pulleys 234. The autonomous mobile carrier unit 200 may be configured to haul a plurality of photovoltaic (PV) solar modules 212. The autonomous mobile carrier unit 200 may further include a controller 250 which may be operatively coupled to a powertrain (not explicitly shown) configured to propel the autonomous mobile carrier unit 200. In some examples, the powertrain may be electric and/or fuel based and may include a gearbox configured to mobilize the autonomous mobile carrier unit 200 to reach torque/speed requirements.

The controller 250 may include a memory, which stores instructions for performing the methods described herein and operating the powertrain, a processor, which may be coupled to the memory and executes the instructions, and a motor driver circuit, which may be coupled to and controlled by the processor according to the executed instructions. The memory may include volatile and non-volatile memory. For example, the memory may include random access memory (RAM) and read-only memory (ROM). The processor may be an application specific integrated circuit (ASIC), a central processing unit (CPU), a microprocessor, or any other suitable circuit for performing the methods described herein and controlling the powertrain based on the instructions stored in memory.

The autonomous mobile carrier unit 200 may include one or more sensors 254 (e.g., collision sensors, vision sensors, LiDAR, radar, cameras, or the like) operatively coupled to the controller 250. The one or more sensors 254 may provide visual data of the surroundings, allowing the autonomous mobile carrier unit 200 to “see” and interpret objects like surrounding solar trackers, other mobile carrier units, the surrounding landscape, and/or other objects. In some examples, the controller 250 may use the information from the one or more sensors 254 to control the operation of the autonomous mobile carrier unit 200. The autonomous mobile carrier unit 200 may also include one or more antennas 252 configured to receive wireless communications, such as instructions and/or GPS protocol.

Further, the controller 250 may include one or more processors configured to utilize control logic stored thereon, the control logic configured to use the information collected via the one or more sensors 254 and/or the one or more antennas 252 to operate the autonomous mobile carrier unit 200. The autonomous mobile carrier unit 200 may further include accelerometers, thermocouples, voltage/current sensors for various subsystems, or the like, operatively coupled to the controller 250.

As will be appreciated, the autonomous mobile carrier unit 200 may include four wheels 238. While it is shown in FIG. 3 that the autonomous mobile carrier unit 200 depicts one side of the unit 200 including two wheels, it will be appreciated that a second side of the autonomous mobile carrier unit 200 is a mirror image and includes two additional wheels, thereby totaling four wheels. The autonomous mobile carrier unit 200 may further include a battery 236. The battery 236 may provide power to the conveyer belt 232, the controller 250, the sensors 254, and in some cases, the robot 230. In some examples, the battery 236 may be a solar powered battery, a lithium-ion battery, a nickel-metal hydride battery, a lead-acid battery, a ultracapacitors battery, or the like.

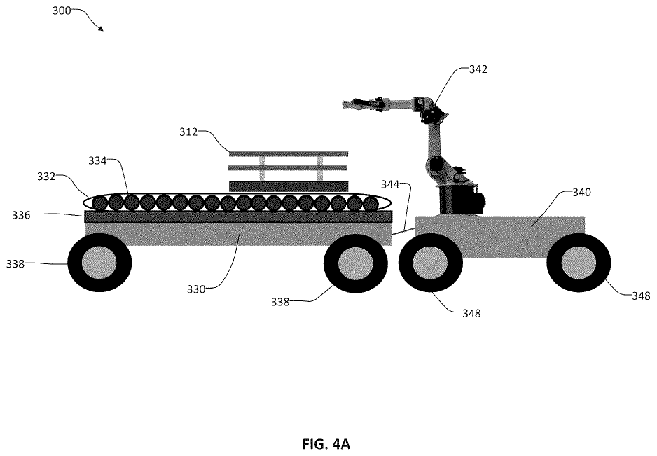

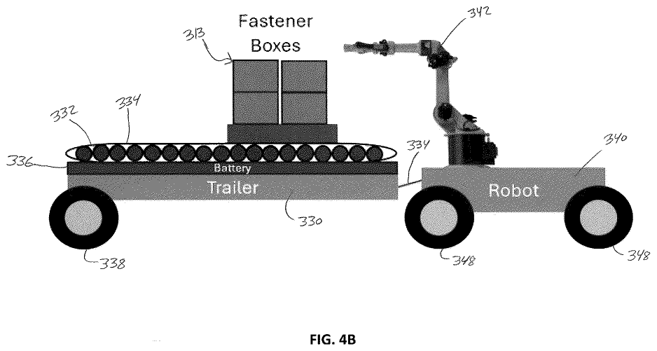

FIG. 4A is a schematic view of a mobile carrier unit 300 including a robot 340 and a trailer 330 having four wheels 338 in accordance with the disclosure, and FIG. 4B is a schematic view of the mobile carrier unit 300 including the trailer 330 having two wheels 348. The mobile carrier unit 300 may be a robotic transport system for loading, unloading, and transporting solar tracker components to/from a solar tracker installation site. As shown in FIGS. 4A and 4B, the mobile carrier unit 300 may include a robot 340 having a robot arm 342, a conveyer belt 332 and a plurality of pulleys 334. The mobile carrier unit 300 may further include a battery 336. The battery 336 may provide power to the conveyer belt 332, and in some cases, the robot 340. In some examples, the battery 336 may be a solar powered battery, a lithium-ion battery, a nickel-metal hydride battery, a lead-acid battery, a ultracapacitors battery, or the like.

As will be appreciated, the trailer 330 of the mobile carrier unit 300 may include four wheels 338. While it is shown in FIG. 4A that the mobile carrier unit 300 depicts one side of the trailer 330 including two wheels, it will be appreciated that a second side of the trailer 330 is a mirror image and includes two additional wheels, thereby totaling four wheels. In some examples, as shown in FIG. 4B, the trailer 330 may include two wheels 338. It will be appreciated that the trailer 330 may include six wheels, eight wheels, or any other suitable number of wheels as desired.

The trailer 330 may be towed behind and controlled by control electronics located on the robot 340. Data may be transferred over short distance wireless connection (Bluetooth) or physically over a wire connection with a tow line 344. In some examples, power can be shared between the robot 340 and the battery 336 of the trailer 330 through power connection of the tow line 344 to extend the range of the robot 340 considerably.

The mobile carrier unit 300 can be configured to transport, and convey along a body of the trailer 330, various types of solar tracker components depending on the application. Such various types of solar tracker components can include ground supports (e.g., piles/beams, frames (e.g., A-frame), etc.), rails (e.g., for supporting photovoltaic modules at a torque tube), fastening components (e.g., for fastening photovoltaic modules to the torque tube, such as via a rail), photovoltaic (PV) solar modules 312, and other solar tracker components. The mobile carrier unit 300 can be configured to move to such one or more various types of solar tracker components along, and relative to, the body of the trailer 330 (e.g., relative to one or more wheels 338, 348). The illustrated embodiments of the mobile carrier unit 300 at FIGS. 4A and 4B includes conveyor 332 to move such one or more various types of solar tracker components along, and relative to, the body of the trailer 330, for instance, to move such various types of solar tracker components into or out of range of the robotic arm 342. In some embodiments, the mobile carrier unit 300 can be configured to use information relating to a type of solar tracker component(s) loaded at the conveyor 332 to determine where at the solar tracker site the mobile carrier unit 300 is to move to (e.g., autonomously based on the type of solar tracker component(s) loaded at the conveyor 332).

For example, the mobile carrier unit 300 can be autonomously moved to different locations at the solar tracker as a function of the solar tracker components loaded at the conveyor 332, and when the mobile carrier unit arrives at the desired location corresponding to the solar tracker components loaded at the conveyor 332, the conveyor 332 can be actuated to move the loaded solar tacker components relative to the robotic arm 342.

For example, as shown at FIG. 4A, the mobile carrier unit 300 may be configured to transport a plurality of PV solar modules 312. Such PV modules 312 can be at a pallet and loaded onto the conveyor 332 at the trailer 330. Then, the mobile carrier unit 300 can be moved (e.g., autonomously) about the solar tracker site to a location where the PV modules 312 are to be unloaded. As described elsewhere herein, the conveyor 332 can be actuated to move the PV modules 312 along the trailer 330 to bring the PV modules 312 into or out of range of the robotic arm 342.

As another shown at FIG. 4B, the mobile carrier unit 300 may be configured to transport other various types of solar tracker components in addition to, or alternative to PV modules. FIG. 4B shows one example where the mobile carrier unit 300 is configured to transport a plurality of solar tracker fastening component members (e.g., screw, bolt, rivet, etc.) 313. Such fastening components 313 can be, as shown herein, held in boxes and loaded onto the conveyor 332 at the trailer 330. Then, the mobile carrier unit 300 can be moved (e.g., autonomously) about the solar tracker site to a location where the fastening components 313 are to be unloaded (e.g., which can be a same or different location as where the PV modules at FIG. 4A are to be unloaded). As described elsewhere herein, the conveyor 332 can be actuated to move the fastening components 313 along the trailer 330 to bring the fastening components 313 into or out of range of the robotic arm 342.

In some embodiments, a controller at the mobile carrier unit can be configured to actuate the conveyor 332 in coordination with control of the robotic arm 342. For example, the controller can include a programmable processor and a non-transitory computer readable medium that stores instructions that, when executed by the programmable processor, cause the controller to control the robotic arm in coordination with movement of the conveyor 332. For instance, the controller can be configured to move the robotic arm 342 relative to the robot unit 340 and conveyor 332 using information relating to actuation of the conveyor 332. In this way, the robotic arm 342 can be controlled to unload solar tracker components from the conveyor 332 when such solar tracker components are positioned along the conveyor 332 within range of the robotic arm 342.

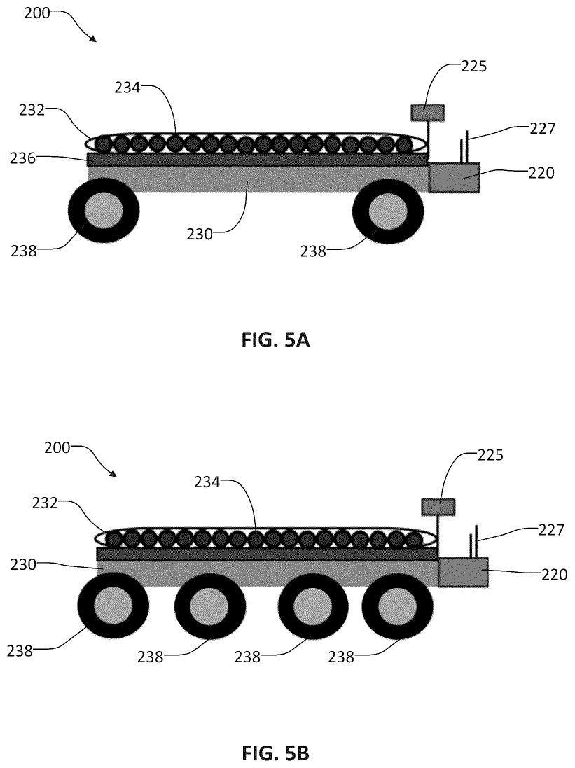

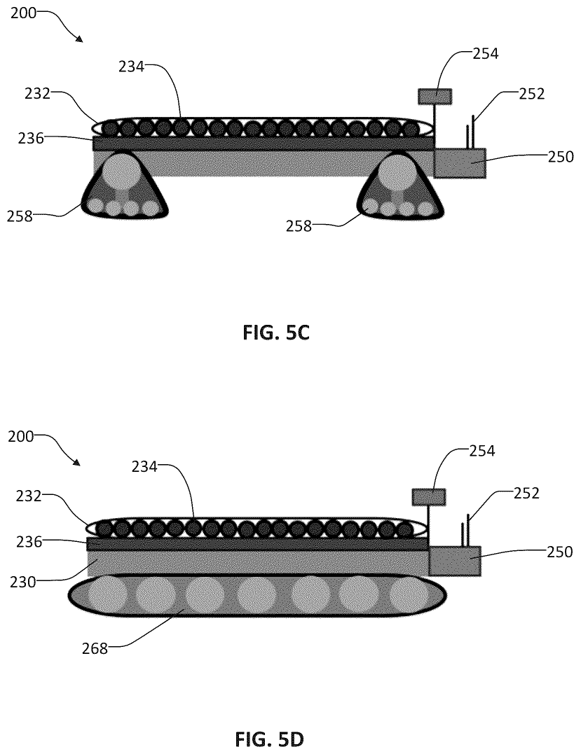

FIGS. 5A to 5D depict schematic views of the autonomous mobile carrier unit 200 having various configurations of wheels. FIG. 5A is a schematic view of the autonomous mobile carrier unit 200 having four wheels 238, FIG. 5B is a schematic view of the autonomous mobile carrier unit 200 having eight wheels 238, FIG. 5C is a schematic view of the autonomous mobile carrier unit 200 having four tracks 258, and FIG. 5D is a schematic view of the autonomous mobile carrier unit 200 having two tracks 268. While it is shown in FIGS. 5A to 5D that the autonomous mobile carrier unit 200 depicts one side of the unit 200, it will be appreciated that a second side of the autonomous mobile carrier unit 200 is a mirror image and includes additional wheels and/or tracks. The tracks 258 and the tracks 268 may be tread-based systems that may include a bolt-track system.

FIG. 6A illustrates various drive train configurations 400 for the autonomous mobile carrier unit 200 and/or the mobile carrier unit 300, and FIG. 6B illustrates various wheel/axle configurations 405 for the autonomous mobile carrier unit 200 and the mobile carrier unit 300. In some examples, the drive train configuration 400 may include a single axle drivetrain 410 which includes a single motor 412 coupled to a rotating connected axle 414 configured to couple a wheel 418 and its counterpart wheel 418. The rotating connected axle 414 may rotate about a singular pivot point 417. In some examples, the axle 414 may be a rotating axle, a stationary axle with a differential, or completely independent.

In some examples, the drivetrain configuration 400 and wheel/axle configuration 405 may include a multi-wheel drivetrain 420 which includes a first motor 422a and a second motor 422b coupled to a rotating, independent axles 424a, 424b, respectively, configured to couple a wheel 428 and its counterpart wheel 428. The rotating independent axles 424a, 424b may each rotate about a pivot point 427a, 427b, respectively. In some examples, the drive train configuration 400 and wheel/axle configuration 405 may include a stationary axle drivetrain 430 which includes a differential 432 coupled to a stationary connected axle 434 configured to couple a wheel 438 and its counterpart wheel 438.

In some examples, the drivetrain configurations 400 may also consist of a single or multi-speed gearbox based on traction requirements. Further, each wheel or axle may have their own spring-damper suspension system, and/or the vehicle may have a single system shared by all axle/wheel systems.

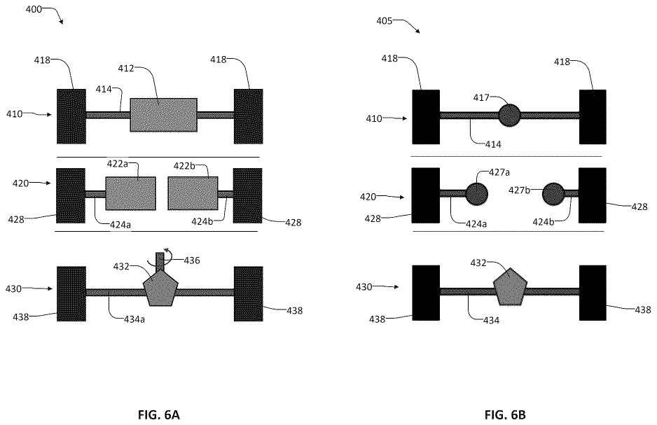

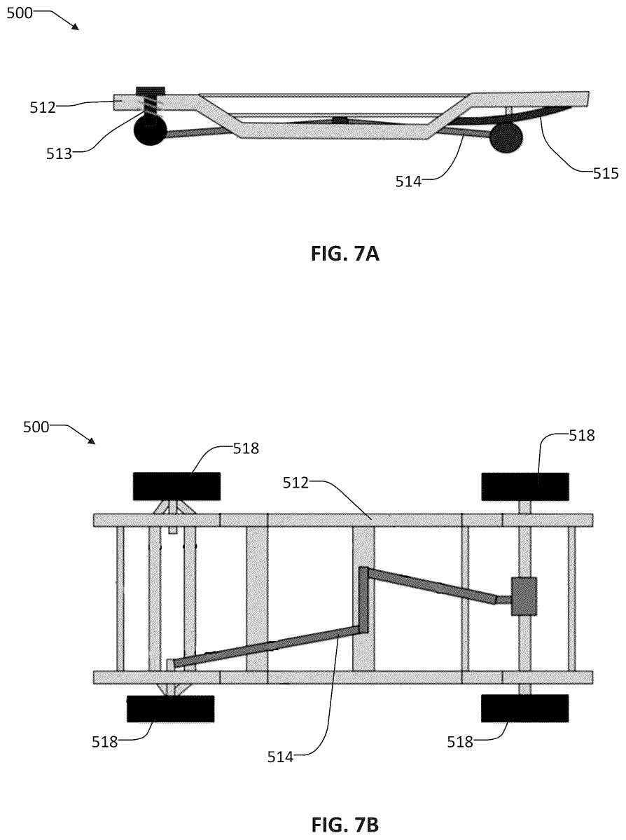

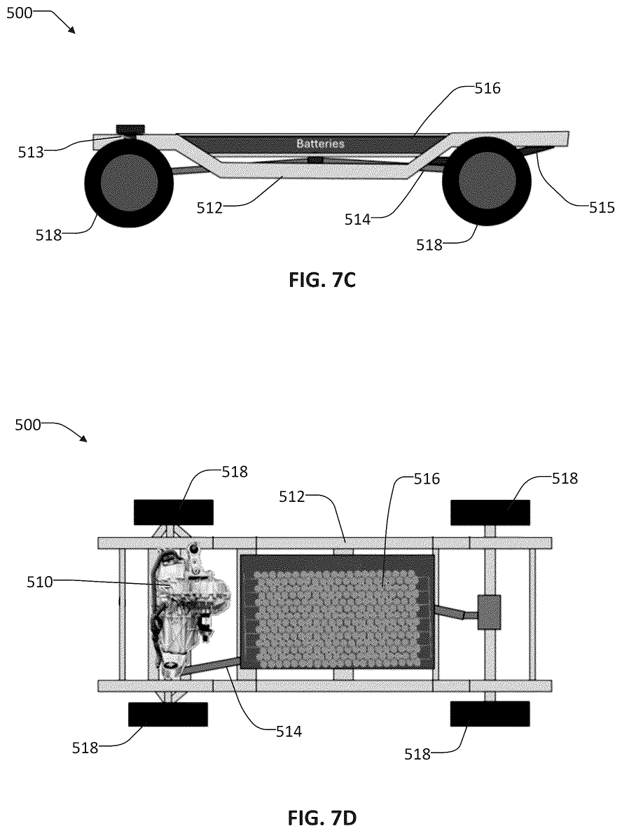

FIGS. 7A to 7D illustrate an example chassis configuration 500 for the autonomous mobile carrier unit 200, and/or the mobile carrier unit 300. The chassis configuration 500, and in some cases, the shape, may vary based on traction configuration, drivetrain configuration, and/or battery configuration. As shown in FIGS. 7A to 7D, the chassis configuration 500 may include a simple, single electric motor 510 connected to a drivetrain 514, and an internal compartment battery 516. The chassis configuration 500 may include a multi axle rear drive via a differential connected to a “ladder” chassis. In some examples, the chassis configuration 500 may include a spring suspension 513 in front and a leaf suspension 515 on rear wheels 518.

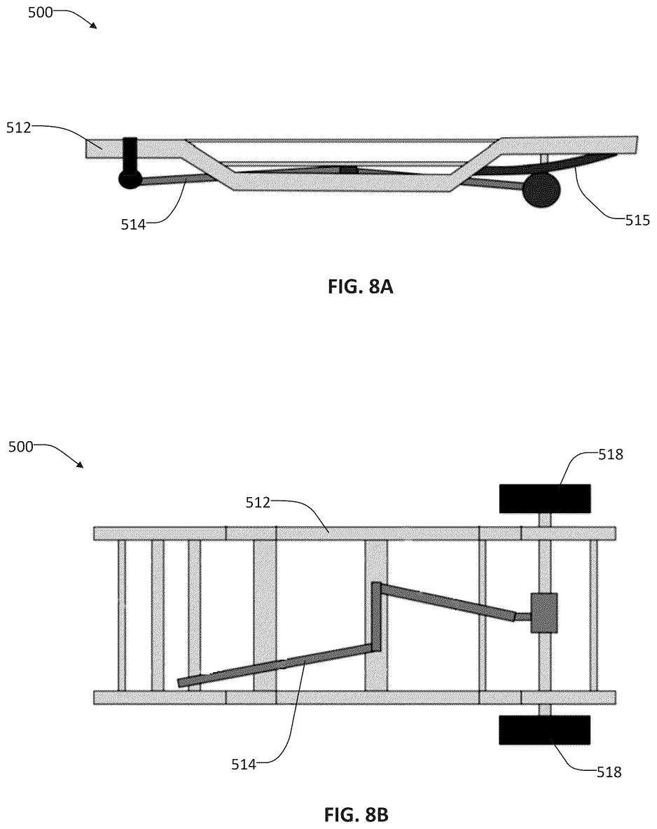

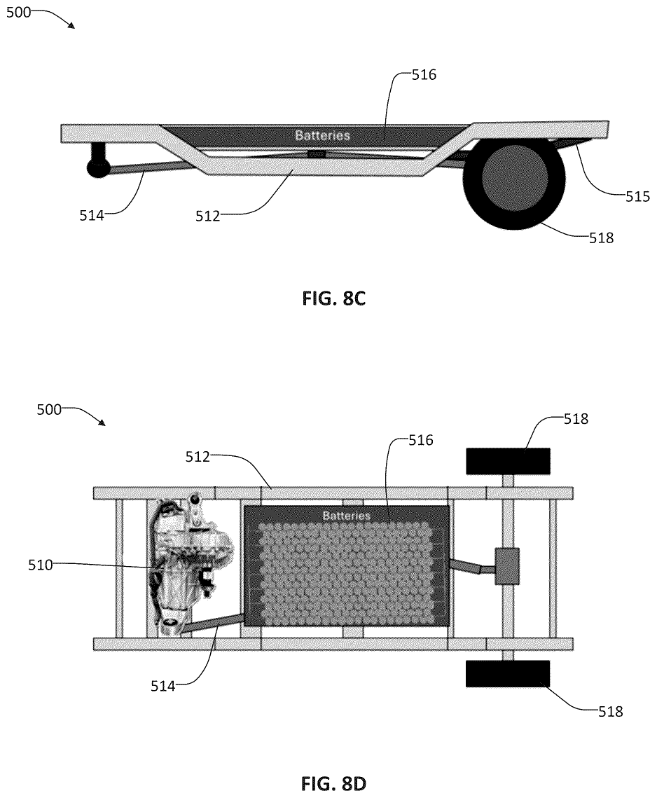

FIGS. 8A to 8D illustrate the example chassis configuration 500 for the autonomous mobile carrier unit 200 and the mobile carrier unit 300 having two wheels 518 rather than four, as shown in FIGS. 7A to 7D.

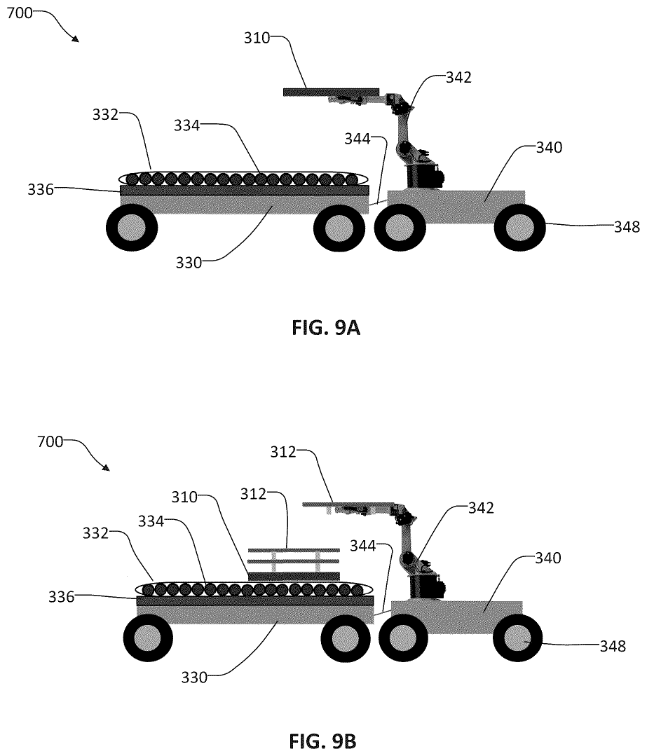

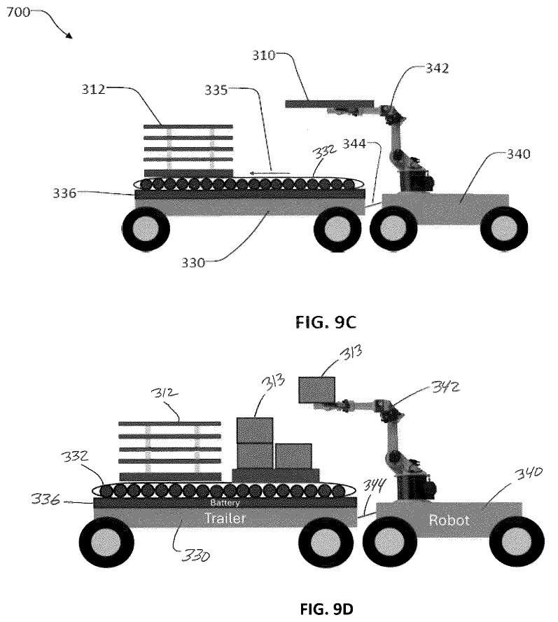

FIGS. 9A to 9D illustrate a method 700 of loading the mobile carrier unit 300. While it is shown in FIGS. 9A to 9D that the method 700 is used for loading the mobile carrier unit 300, the method 700 further applies to loading of the autonomous mobile carrier unit 200. The mobile carrier unit 300 and/or the autonomous mobile carrier unit 200 payload may be loaded via: human workers, robotic arms 342, and/or self-loading via winch/chain-drive system. Different loading conditions may require specific drivetrain, wheel, battery or sizing configurations to ensure viability. Each mobile carrier unit 300 and/or autonomous mobile carrier unit 200 might carry one or more payloads depending on payload weight and robot capacity.

The method 700 may include the robot arm 342 loading a pallet 310 on the conveyer belt 332, as shown in FIG. 9A. Then the robot arm 342 may begin to load payload (e.g., PV solar module panels 312, fastening components 313, and/or ground supports) onto the pallet 310, as shown in FIG. 9B. Once full, the conveyer belt moves the pallet 310 to the back of the conveyer belt 332, as shown in FIG. 9C, and the next pallet 310 is loaded, as shown in FIG. 9D. These steps are repeated until the mobile carrier unit 300 and/or the autonomous mobile carrier unit 200 are loaded to capacity with any variety of types of solar tracker components, for instance, depending on the location at the solar tracker site that the mobile carrier unit 300 is to transport the solar tracker components.

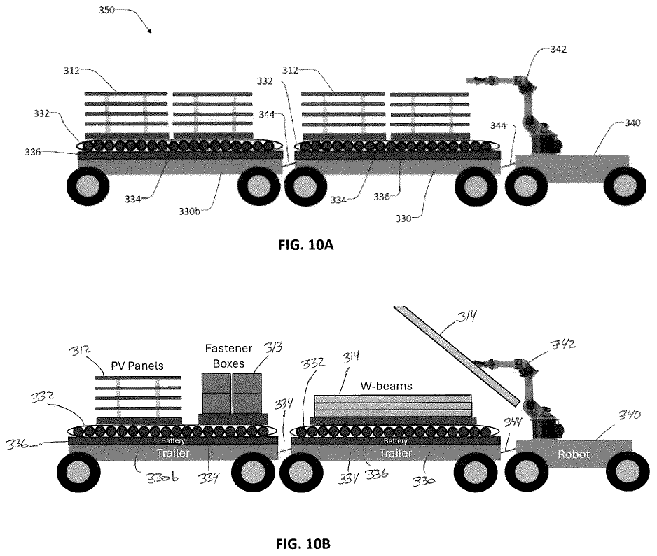

FIGS. 10A and 10B illustrate a further exemplary mobile carrier unit 350, including the robot 340 and a second trailer 330b, in addition to the first mobile carrier unit 330.

FIG. 10A shows solar module components 312 as a type of solar tracker component transported by the mobile carrier unit 350. As shown here, the mobile carrier 350 can include the robot 342 and the second trailer 330b. The mobile carrier unit 350 may be like the mobile carrier unit 300 except that the mobile carrier unit 350 includes the second trailer 330b. Therefore, the description of the mobile carrier unit 300 described herein can further apply to the mobile carrier unit 350.

FIG. 10B shows different types of solar module components loaded and moved at the mobile carrier unit 350 in sequence corresponding to the specific types of different solar tracker components at the mobile carrier unit. For instance, the example application shown at FIG. 10B has includes ground supports (e.g., piles, beams (e.g., I-beam; W-beam), frames, such as A-frames) 314, followed by fasteners 313, followed by solar modules 312, moving in a direction away from the robotic arm 342. Accordingly, the controller of the mobile carrier unit 350 can be configured to coordinate movement of the conveyor 332 with movement of the robotic arm 342 to unload different solar tracker components in a desired order at a particular location at the solar tracker site.

For instance, at the example at FIG. 10B, the controller can be configured to: (i) actuate the robotic arm 342 to unload the ground supports 314, (ii) move the conveyor 332 at the second trailer 330b to move the fasteners 313 and the PV modules 312 toward the trailer 330, including, for instance, moving the fasteners 313 from the conveyor 332 at the second trailer 330b to the conveyor 332 at the trailer 330, (iii) then move the conveyor 332 at the second trailer 330b to bring the fasteners 313 within range of the robotic arm 342. Likewise, after the fasteners 313 have been unloaded at a specified location at the solar tracker site, a second sequence can be used by the controller to similarly move the conveyor 332 at the second trailer 330b to bring the PV modules 312 within range of the robotic arm 342. In this way, the controller at the unit 350 can be configured to coordinate movement of conveyors 332 at different trailers as a function of the intended unloading location at the solar tracker site and the type of solar tracker components loaded at the conveyors 332.

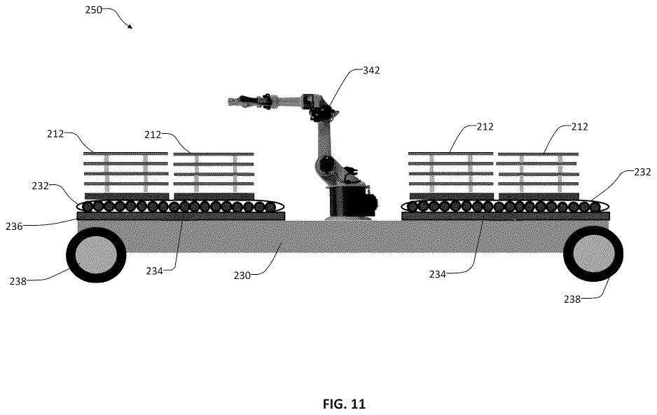

FIG. 11 is another example autonomous mobile carrier unit 260 in accordance with the disclosure. The autonomous mobile carrier unit 260 may be like the autonomous mobile carrier unit 200 except that the autonomous mobile carrier unit 260 includes a longer robot 230 having two conveyer belts 232, and the robot arm 342. Thus, the description of the autonomous mobile carrier unit 200 described herein further applies to the autonomous mobile carrier unit 260.

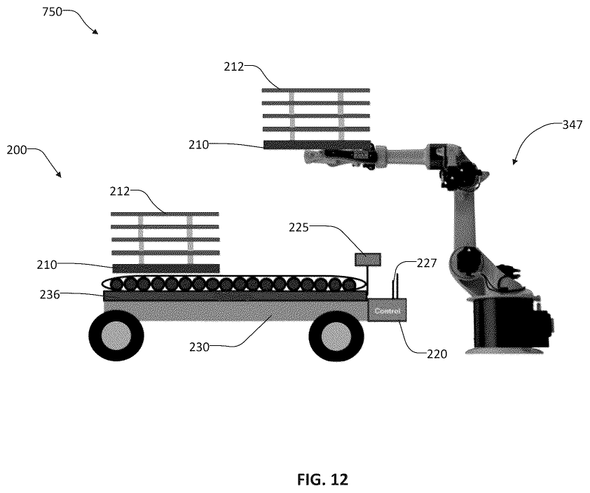

FIG. 12 illustrates a method 750 of loading the autonomous mobile carrier unit 200. As shown in FIG. 12, a large, ground mounted arm 347 can be used in place of smaller, vehicle mounted arm (e.g., robot arm 342) for pre-loaded pallets or larger objects. The method 750 may include the robot arm 347 loading a pallet 210 on the conveyer belt 232. Then the robot arm 347 may begin to load payload (e.g., PV solar modules 212) onto the pallet 210. Once full, the pallet 210 is moved to the back of the conveyer belt 232, and the next pallet 210 is loaded, as shown in FIG. 12. These steps are repeated until the mobile carrier unit 300 and/or the autonomous mobile carrier unit 200 are loaded to capacity.

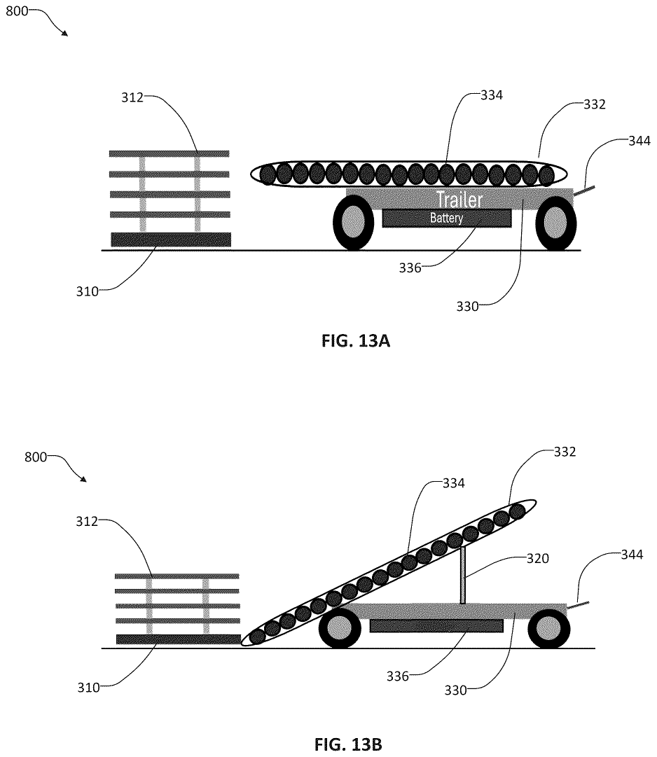

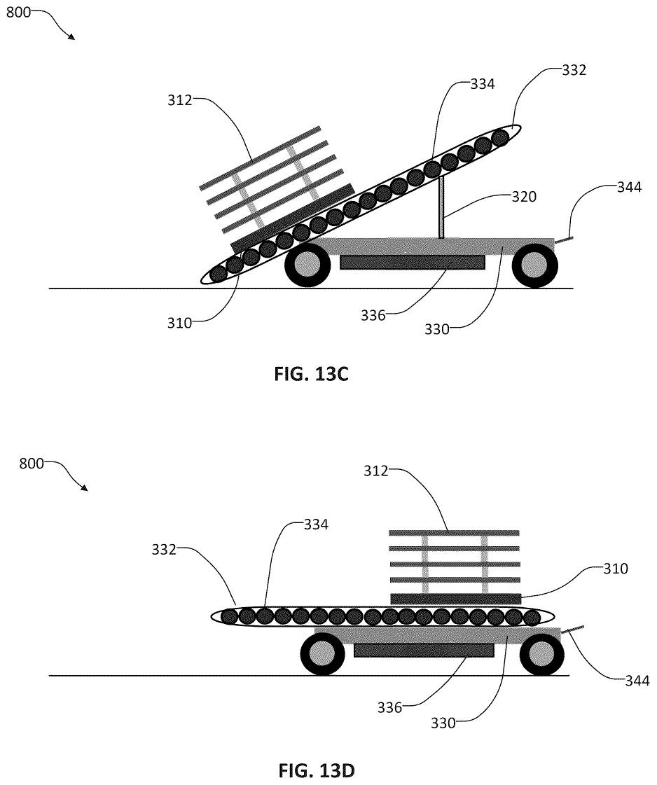

FIGS. 13A to 13D illustrate a method 800 of loading the trailer 330 of the mobile carrier unit 300, and/or the robot 230 of the autonomous mobile carrier unit 200. As shown in FIG. 13A, the trailer 330 and/or the robot 230 reverse up to a pre-loaded pallet 310. The conveyer belt 332 may then rotate around a rear mount via a linear actuator 320, as shown in FIG. 13B. The conveyer belt 332 may then begin to rotate and hooks on the conveyer belt 332 may “grab” the pallet 310 and pull it up onto the conveyer belt 332, as shown in FIG. 13C. The conveyer belt 332 may then return to a horizontal position for transport, with the loaded pallet 310 in position, as shown in FIG. 13D.

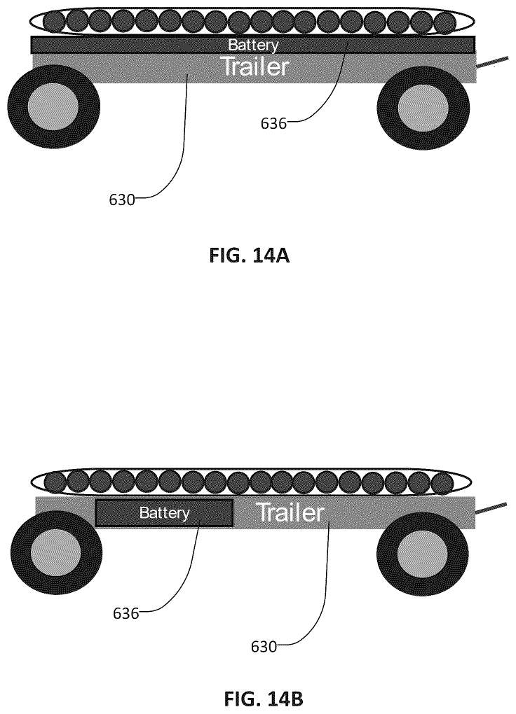

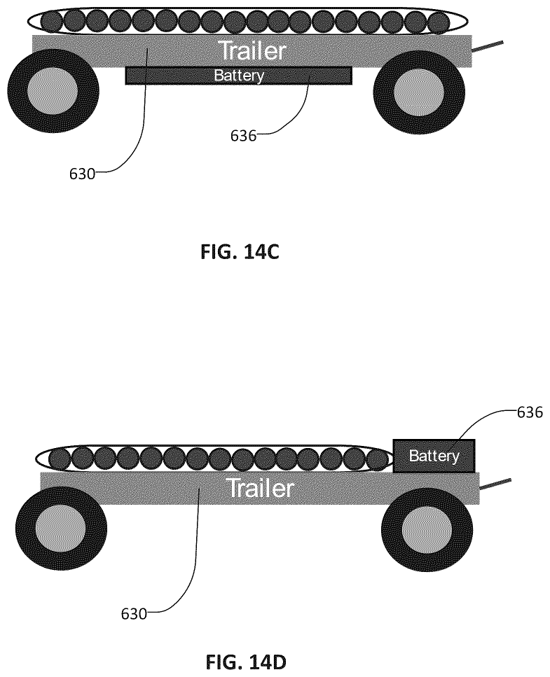

FIGS. 14A to 14D illustrate various arrangements of a battery 636 and a trailer 630, in accordance with the present disclosure. While the trailer 630 is shown in FIGS. 14A to 14D, it will be appreciated that the description of FIGS. 14A to 14D further apply to the autonomous mobile carrier unit 200 described elsewhere herein.

As shown in FIGS. 14A to 14D, the battery 636 may be a large, removable battery, that may be contained internally or externally based on access requirements. In some examples, the battery 636 may be an external battery configured to held in a slot or compartment, as shown in FIG. 14A. In some examples, the battery 363 may be an internal battery configured to fit within an internal Battery compartment that may be shaped to precisely fit and hold battery 636 in place, or be loosely contained therein, as shown in FIG. 14B. In some examples, the battery 636 may be an external battery configured to held in a sling, as shown in FIG. 14C. In some examples, the battery 636 may be an external battery configured to held in a backpack, as shown in FIG. 14D.

In some examples, an energy management system may allow bidirectional charging. For example, each unit (e.g., unit 200, unit 300) may each include a standardized I/O port for: inputting power to directly charge battery(s) without removal, output power for external items/tools, and bus connection for BMS/control hardware. The mobile carrier unit 300 may include the ability to transfer power to and from the battery 636 across the tow line wire (e.g., tow line 344) connection (in addition to the access port). Further, the mobile carrier unit 300 may use multiple lines of cable up to 4/0 AWG depending on continuous current, and may be used for charging or powering exterior objects similar to I/O port. In some examples, the autonomous mobile carrier unit 200 may have a secondary, much smaller battery to allow for limited operability when large battery 636 is disconnected for charging.

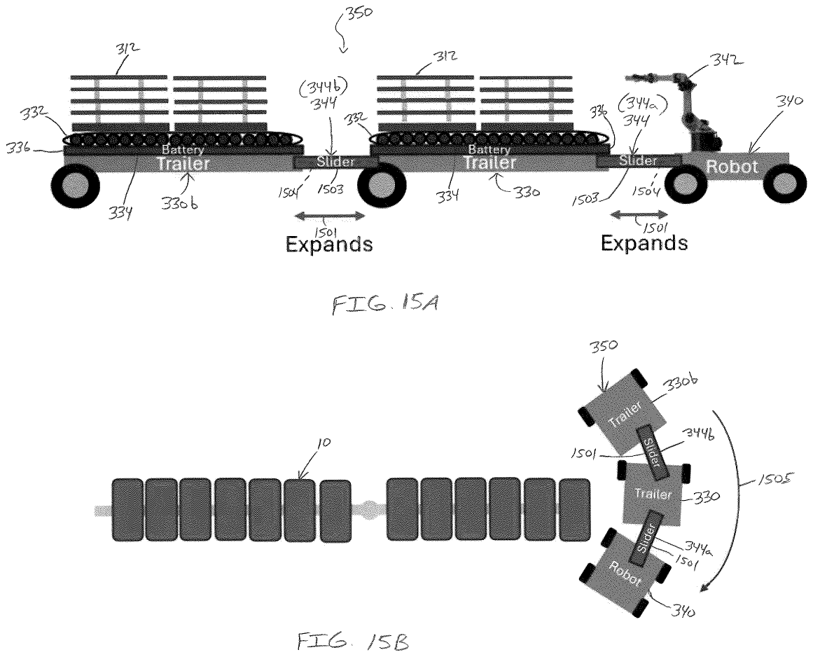

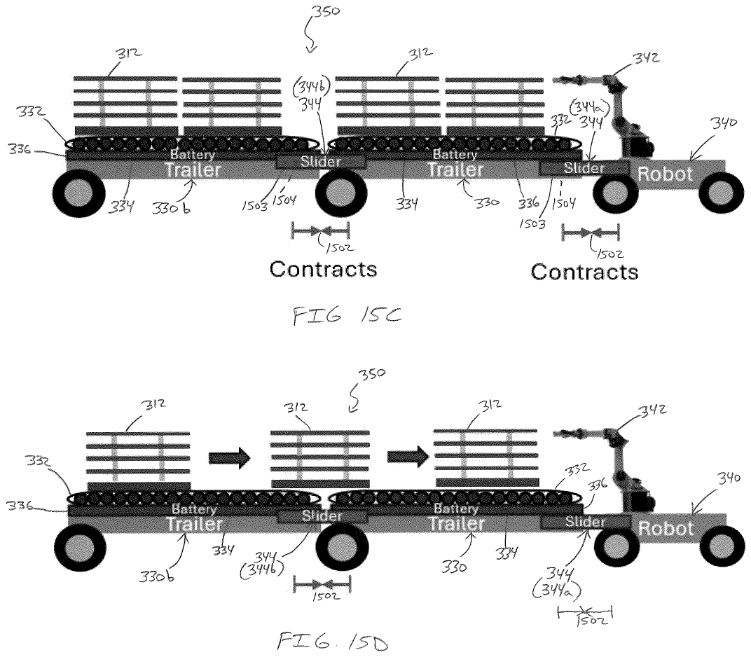

FIGS. 15A-15D illustrate an additional example mobile carrier unit 350. FIGS. 15A-15D illustrate the mobile carrier unit 350 as including an expandable and contractable tow line 344 between mobile components of the mobile carrier unit 350. More specifically, FIGS. 15A-15D illustrate the mobile carrier unit having a first expandable and contractable tow line 344a between the robot 340 and the first trailer 330 and a second expandable and contractable tow line 344b between the first trailer 330 and the second trailer 330b. While FIGS. 15A-15D illustrate the expandable and contractable tow line 344 as present between each of the mobile components (the first expandable and contractable tow line 344a between the robot 340 can the first trailer 330 and the second expandable and contractable tow line 344b between the first trailer 330 and the second trailer 330b), in other embodiments the mobile carrier unit 350 can have the expandable and contractable tow line 344 present between less than each of the mobile components.

The expandable and contractable tow line 344 can be configured to expand and contract to thereby change a distance between the mobile components that the expandable and contractable tow line 344 connects (e.g., first tow line 344a is configured to expand and contract to change a distance between the robot 340 and first trailer 330 and/or second tow line 344b is configured to expand and contract to change a distance between the first trailer 330 and the second trailer 330b). For example, the expandable and contractable tow line 344 can be actuated to change the distance separating mobile components of the mobile carrier unit 350 depending on the application, or use case, of the mobile carrier unit 350. As the mobile carrier unit 350 traverses around a solar tracker site, certain applications of the mobile carrier unit 350 at certain solar tracker site locations can benefit from a relatively larger distance between mobile components of the mobile carrier unit 350, while other applications of the mobile carrier unit 350 at other solar tracker site locations can benefit from a relatively smaller distance between mobile components of the mobile carrier unit 350. As the example at FIGS. 15A and 15B illustrates, for instance, the expandable and contractable tow line 344 can be in an expanded position 1501 when the mobile carrier unit 350 is turning direction, such as making a turn between solar tracker rows, while the example at FIGS. 15C and 15D illustrates that the expandable and contractable tow line 344 can be in a contracted position 1502 when the mobile carrier unit 350 is moving payload between trailers and/or unloading payload. The relatively greater distance between mobile components of the mobile carrier unit 350 when the expandable and contractable tow line 344 is at the expanded position 1501 can, for instance, help to enable a relatively tighter turning radius for the mobile carrier unit 350, while the relatively smaller lesser distance between mobile components of the mobile carrier unit 350 when the expandable and contractable tow line 344 is at the contracted position 1502 can, for instance, help to enable transfer of payload from one trailer to another and/or from one trailer to the robotic arm 342.

As noted, FIGS. 15A and 15B show the mobile carrier unit 350 having the expandable and contractable tow lines 344a, 344b at an example expanded position 1501. The expanded position 1501 of the tow lines 344a, 344b can define a greater distance, respectively, between the robot 340 and the first trailer 330 and between the first trailer 330 and the second trailer 330b as compared to the contracted position 1502 at FIGS. 15C, 15D. The expanded position 1501 of the tow lines 344a, 344b can be useful for the mobile carrier unit 350 in changing directions. For instance, the tow lines 344a and/or 344b can be actuated to increase separation between two given mobile components of the mobile carrier unit 350 and this increased separation via actuation of the tow lines 344a and/or 344b can act to enable a tighter turning radius 1505 for the mobile carrier unit 250 as compared to a lesser separation between given mobile components of the mobile carrier unit 350 (e.g., as compared to when the tow lines 344a and/or 344b are at the contracted position 1502). Actuating the tow lines 344a and/or 344b to the expanded position 1501 can, thus, be useful, such as shown at FIG. 15B, when the mobile carrier unit 350 approaches a north or south end of solar tracker 10 row to enable the mobile carrier unit 350 to turn about the north or south end of the row.

As also noted, FIGS. 15C and 15D show the mobile carrier unit 350 having the expandable and contractable tow lines 344a, 344b at an example contracted position 1502. The contracted position 1502 of the tow lines 344a, 344b can define a lesser distance, respectively, between the robot 340 and the first trailer 330 and between the first trailer 330 and the second trailer 330b as compared to the expanded position 1501 at FIGS. 15A, 15B. The contracted position 1502 of the tow lines 344a, 344b can be useful for the mobile carrier unit 350 in transferring payload relative to the mobile carrier unit 350. For instance, the tow lines 344a and/or 344b can be actuated to decrease separation between two given mobile components of the mobile carrier unit 350 and this decreased separation via actuation of the tow lines 344a and/or 344b can act to enable more effective transfer of payload from one mobile component of the mobile carrier unit 35 to another, adjacent mobile component of the mobile carrier unit 350 as compared to a greater separation between given mobile components of the mobile carrier unit 350 (e.g., as compared to when the tow lines 344a and/or 344b are at the expanded position 1501). Actuating the tow lines 344a and/or 344b to the contracted position 1502 can, thus, be useful, such as shown at FIG. 15D, when the mobile carrier unit 350 is to be used to convey payload along the mobile carrier unit 350. For instance, the mobile carrier unit 350 can be configured to actuate the tow lines 344a and/or 344b to the contracted position 1502 prior to or during actuation of the conveyor 332. In this way, the distance separating the first trailer 330 and the second trailer 330b can be small enough that that the conveyor 332 can convey payload 312 from the second trailer 330b to the conveyor 332 at the first trailer 330 and/or the conveyor 332 can convey payload 312 from the first trailer 330 to the robotic arm 342. In one specific such example, the mobile carrier unit 350 can be configured such that when an actuation command is received to start the conveyor 332 and the tow line 344 is at the expanded position 1501, the mobile carrier unit 350 is configured to first move the tow line from the expanded position 1501 to the contracted position 1502 before the mobile carrier 350 implements the actuation command to start the conveyor 332. Thus, for some embodiments, the conveyor(s) 332 and/or the robotic arm 342 can be transitioned from a disabled state to an enabled state when the tow line 344 is at the contracted position 1502.

To enable the expandable and contractable tow line 344 to transition between the expanded position 1501 and the contracted position 1502, the expandable and contractable tow line 344 can include a slider mechanism 1503. The slider mechanism 1503 can be movable between the expanded position 1501 and the contracted position 1502 to thereby transition the tow line 344 between the expanded position 1501 and the contracted position 1502 as a result of movement of the slider mechanism 1503. For example, the slider mechanism 1503 can separate to move the tow line 244 to the expanded position 1501, and the slider mechanism 1503 can squeeze together to move the tow line 244 to the contracted position 1502.

The slider mechanism 1503 can be movable between the expanded and contracted tow line positions while maintaining electrical power transmission between the mobile components connected via the slider mechanism 1503. As described elsewhere herein, the tow line 344 can provide a power conveyance line 1504 between mobile components of the mobile carrier unit 350. For example, the tow line 344 can provide electrical power transmission from one trailer 330 to another trailer 330b and/or to/from the robot 340 and one or more trailers 330, 330b via the power conveyance line 1504 at the tow line 344. The slider mechanism 1503 can be configured to accommodate the power conveyance line 1504 thereat in both the expanded and contracted positions 1501, 1502. For example, the power conveyance line 1504 can be at the slider mechanism 1503 such that the power conveyance line 1504 is configured to transmit power between mobile components of the mobile carrier unit 350 when the slider mechanism 1503 is at both the expanded position 1501 and the contracted position 1502. In some such examples, the power conveyance line 1504 can be indexed relative to the slider mechanism 1503 such that the power conveyance line 1504 is configured to expand with the slider mechanism 1503 when moving to the expanded position 1501 and configured to contract with the slider mechanism 1503 when moving to the contracted position 1502. For instance, the power conveyance line 1504 can be provided with an extent of slack along its length so that the power conveyance line 1504 can move with the slider mechanism 1503 between the expanded and contracted positions 1501, 1502.

Various non-limiting exemplary embodiments have been described. It will be appreciated that suitable alternatives are possible without departing from the scope of the examples described herein.

What is claimed is:

1. An autonomous mobile carrier unit comprising:
a controller,
a motive source coupled to the controller,
one or more wheels coupled to the motive source to autonomously move the autonomous mobile carrier unit, and
a conveyor mechanism coupled to the controller, the conveyor mechanism configured to move one or more solar tracker components along the conveyor mechanism, relative to the one or more wheels.

2. The unit of claim 1, further comprising:
a robotic arm that is configured to move relative to the conveyor mechanism, the robotic arm configured to attach to the one or more solar tracker components at the conveyor mechanism.

3. The unit of claim 2, wherein the controller is configured coordinate movement of the conveyor mechanism and the robotic arm using information relating to actuation of the conveyor.

4. The unit of claim 2, further comprising a body, the body including the controller, the motive source, the one or more wheels, the conveyor mechanism, and the robotic arm as an integrated unit.

5. The unit of claim 2,
wherein the one or more wheels comprise a first wheel and a second wheel, and
wherein the unit further comprises:
a first body, the first body comprising the first wheel and the conveyor mechanism; and
a second different body, the second different body connected to the first body such that the first and second bodies move together, the second body comprising: the second wheel and the robotic arm.

6. The unit of claim 5, wherein the first body and the second body are electrically connected to convey power from a battery at one of the first body and the second body to the other of the first body and the second body.

7. The unit of claim 6, wherein the autonomous mobile carrier unit further comprises:
a slider mechanism extending between the first body and the second body, the slider mechanism configured to move between an expanded position and a contracted position, wherein a distance between the first body and the second body is greater when the slider mechanism is at the expanded position than when the slider mechanism is at the contracted position.

8. The unit of claim 7, wherein the first body and the second body are electrically connected via a power conveyance line extending between the first body and the second body, and wherein the power conveyance line is indexed relative to the slider mechanism.

9. The unit of claim 8, wherein the power conveyance line is configured to move with the slider mechanism between the expanded position and the contracted position.

10. The unit of claim 7, wherein the controller is configured coordinate movement of the conveyor mechanism and the robotic arm using information relating to actuation of the conveyor, and wherein the controller is configured to disable the conveyor mechanism when the slider mechanism is at the expanded position and to enable the conveyor mechanism when the slider mechanism is at the contracted position.

11. The unit of claim 1, further comprising a body, the body including at least one of the one or more wheels and the conveyor mechanism, and wherein the body comprises a ladder chassis that supports the conveyor mechanism.

12. The unit of claim 11, wherein the ladder chassis comprises a compressive spring suspension at one end portion of the body and a leaf spring suspension at another opposite end portion of the body.

13. The unit of claim 12, wherein the motive source comprises a battery coupled to an electric motor, and wherein the battery is carried at the body at least between the compressive spring suspension and the leaf spring suspension.

14. The unit of claim 13, wherein the electric motor is carried at the end portion of the body comprising the compressive spring suspension.

15. The unit of claim 1, wherein the one or more wheels comprise a first wheel and a second wheel, the first wheel controllable by the controller independent of the second wheel.

16. The unit of claim 1, wherein the conveyor mechanism comprises a length sufficient to receive at least two spaced apart pallets of solar tracker components thereat, and wherein the conveyor mechanism is configured to pivot relative to the one or more wheels to change an inclination angle of the conveyor mechanism.

17. The unit of claim 16, wherein the robotic arm is configured to attach to one or more of a first set of solar tracker components at a first time, wherein the conveyor mechanism is configured to move a second set of solar tracker components along the conveyor mechanism relative to the one or more wheels at a second, later time, and wherein the robotic arm is configured to remove the second set of solar tracker components from the conveyor after the second set of solar tracker components has been moved along the conveyor mechanism.

18. The unit of claim 1, wherein the one or more solar tracker components comprise a first type of solar tracker component and a second, different type of solar tracker component, wherein each of the first and second types of solar tracker components are selected from the group consisting of: a ground support, a fastener, and a solar module.

19. The unit of claim 18, wherein the first type of solar tracker component is at a first location along the conveyor mechanism, and wherein the second type of solar tracker component is at a second location that is spaced apart from the first location along the conveyor mechanism.

20. A method of transporting solar tracker components, the method comprising the steps of:
receiving solar tracker component information relating to one or more types of solar tracker components loaded at a mobile carrier;
using the solar tracker component information to determine a location to which to transport the solar tracker components loaded at a mobile carrier; and
when the mobile carrier unit is at the location, actuating a robotic arm to remove the solar tracker components from the mobile carrier at the location.

21. The method of claim 20, wherein the solar tracker components loaded at the mobile carrier comprise a first type of solar tracker component and a second, different type of solar tracker component.

22. The method of claim 21,
wherein the first type of solar tracker component is selected from the group consisting of: a ground support, a fastener, and a solar module, and wherein the second type of solar tracker component is selected from the group consisting of: a ground, a fastener, and a solar module,
wherein the first type of solar tracker component is loaded at a first location along a conveyor at the mobile carrier, and wherein the second type of solar tracker component is loaded at a second location that is spaced apart from the first location along the conveyor, and
further comprising the steps of:
after the robotic arm is actuated to remove the first type of solar tracker component from the conveyor, imparting movement of the second type of solar tracker component, relative to one or more wheels at the mobile carrier, to move the second type of solar tracker component within range of the robotic arm; and
after moving the second type of solar tracker component closer to the robotic arm, actuating the robotic arm to remove the second type of solar tracker components from the conveyor at the location.

23. The method of claim 22, further comprising the steps of:
pivoting the conveyor, relative to one or more wheels at the mobile carrier, from a first orientation to a second, different orientation; and
when the conveyor is at the second orientation, loading the first type of solar tracker component using at least movement of the conveyor at the second orientation and then loading the second type of solar tracker component using at least movement of the conveyor at the second orientation.
